(19) United States
(12) Patent Application Publication
(10) Pub. No.: US 2016/0267923 A1
(43) Pub. Date: Sep. 15, 2016

(54) COMMUNICATION APPARATUS, COMMUNICATION SYSTEM, METHOD OF STORING LOG DATA, AND STORAGE MEDIUM

(71) Applicant: Tomoyuki GOTO, Kanagawa (JP)

(72) Inventor: Tomoyuki GOTO, Kanagawa (JP)

(21) Appl. No.: 15/055,829

(22) Filed: Feb. 29, 2016

(30) Foreign Application Priority Data
Mar. 9, 2015 (JP) 2015-045959

(51) Int. Cl. G10L 25/72; G10L 25/21; G10L 25/18

(52) U.S. Cl. CPC G10L 25/72; G10L 25/18; G10L 25/21; G10L 2021/02082

(57) ABSTRACT

A communication apparatus includes an audio output unit to output primary audio data received from a counterpart communication apparatus to an acoustic environment of the communication apparatus, an audio acquisition unit to collect secondary audio data from the acoustic environment, the collected secondary audio data is transmitted to the counterpart communication apparatus, a property acquisition unit to acquire property data of audio based on the collected secondary audio data, and a storage unit to store the acquired property data of audio added with date data when the property data of audio is acquired as log data.

### CROSS-REFERENCE TO RELATED APPLICATIONS

This patent application is based on and claims priority pursuant to 35 U.S.C. §119(a) to Japanese Patent Application No. 2015-045959, filed on Mar. 9, 2015, in the Japan Patent Office, the entire disclosure of which is hereby incorporated by reference herein.

### BACKGROUND

1. Technical Field

The present invention generally relates to a system to identify a cause of audio condition failure on a teleconference such as a video conference and a telephone conference.

2. Description of the Related Art

When a teleconference such as a video conference or a telephone conference is held between one video conference apparatus and a counterpart video conference apparatus, the one video conference apparatus receives audio data such as voice data from the counterpart video conference apparatus. In this configuration, users may feel oddness if the voice data received from the counterpart video conference apparatus includes noise, if the commented contents cannot be received clearly, if the voice data from the counterpart video conference apparatus is interrupted and not heard, and if the voice made at the one video conference apparatus returns back from the counterpart video conference apparatus as an echo. In this case, the users determine that the video conference apparatus and video conference system may have failure or malfunction, and request a service station of a vendor of the video conference apparatus to repair the failure and malfunction, in which the malfunctioned video conference apparatus is returned to the service station, and then the service person performs an test operation to confirm the failure phenomenon. However, since the service person cannot reproduce the exact environment of the users at the service station, the service person cannot confirm the failure phenomenon occurred at the user environment.

The audio failure may be related to the user environment such as noise, reverberant sound occurred by a reflection of audio or noise on a wall of a conference room, and levels of voice. Further, since the audio failure felt by the users is reported to the service person by a written sheet, the service person cannot comprehend the audio failure exactly. The audio data during a conference can be recorded so that the service person can repair the audio failure by referring the recorded audio. However, since the recorded audio includes contents including confidential matters, confidentiality of communication of the users cannot be secured if the service person listens the recorded audio.

### SUMMARY

As one aspect of the present invention, a communication apparatus is devised. The communication apparatus includes an audio output unit to output primary audio data received from a counterpart communication apparatus to an acoustic environment of the communication apparatus, an audio acquisition unit to collect secondary audio data from the acoustic environment, the collected secondary audio data is transmitted to the counterpart communication apparatus, a property acquisition unit to acquire property data of audio based on the collected secondary audio data, and a storage unit to store the acquired property data of audio added with date data when the property data of audio is acquired as log data.

As another aspect of the present invention, a communication system is devised. The communication system includes two or more of the communication apparatuses of the above communication apparatus, and a server to communicate data with the two or more of the communication apparatuses. Each of the communication apparatus includes a log data transmission unit to transmit the log data acquired from the storage unit to the server, and the server includes an analyzer to analyze one or more failure factors indicated in the secondary audio data based on the log data received from the communication apparatus.

As another aspect of the present invention, a method of storing log data for a communication apparatus is devised. The method includes outputting a primary audio data received from a counterpart communication apparatus to an acoustic environment of the communication apparatus, collecting secondary audio data from the acoustic environment, transmitting the collected secondary audio data to the counterpart communication apparatus, acquiring property data of audio based on the collected secondary audio data, and storing the acquired property data of audio added with date data when the property data of audio is acquired as log data.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration of a conference system of one or more example embodiments of the present invention;

FIG. 2 is a schematic view of an operation of the conference system of one or more example embodiments of the present invention;

FIG. 3 is an example of a hardware configuration of a video conference apparatus of one or more example embodiments of the present invention;

FIG. 4 is an example of a functional configuration of the conference system of one or more example embodiments of the present invention;

FIG. 5 is a flowchart showing the steps of a process of the conference system of one or more example embodiments of the present invention;

FIG. 6 is a flowchart showing the steps of a process of a video conference apparatus at a reception side of one or more example embodiments of the present invention;

FIG. 7 is a scheme of detecting a failure point of the conference system of one or more example embodiments of the present invention;

FIG. 8A illustrates an example of screen display when a conference is held between two sites;

FIG. 8B illustrates an example of screen display when a conference is held between three or more sites;

FIG. 9 is a schematic view of environment where the video conference apparatus is placed, in which the video conference apparatus may receive various effect from the environment.

FIG. 10 is a schematic chart for setting a timing of inputting audio such as voice to the video conference apparatus of one or more example embodiments of the present invention;

FIG. 11 is a flowchart showing the steps of a control process of acquiring audio data by using the video conference apparatus of one or more example embodiments of the present invention;

FIG. 12 is a sequential chart of an operation of uploading log data when an audio failure occurs at the video conference apparatus of one or more example embodiments of the present invention; and

FIG. 13 is a flowchart showing the steps of a process of analyzing log data by a server of one or more example embodiments of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

A description is given of one or more example embodiments of a communication apparatus of one or more example embodiments of the present invention the present invention with reference to drawings. The communication apparatus of one or more example embodiments of the present invention includes a following configuration that can record log data to check audio failure status under the condition of securing confidentiality of communication.

Specifically, when the communication apparatus (first communication apparatus) receives primary audio data from a counterpart communication apparatus (second communication apparatus), the communication apparatus (first communication apparatus) outputs the received primary audio data to an acoustic environment from a speaker, and collects secondary audio data from the acoustic environment by using a microphone. Then, the communication apparatus (first communication apparatus) transmits the collected secondary audio data to the counterpart communication apparatus. The communication apparatus (first communication apparatus) includes, for example, an audio acquisition unit such as the microphone to acquire the secondary audio data, a property acquisition unit to acquire property data indicating audio based on the secondary audio data, and a storage unit to store the log data composed of the property data added with date data when the property data is acquired. With this configuration, the communication apparatus can record log data to check audio failure status under the condition of securing confidentiality of communication.

### (Configuration of Conference System)

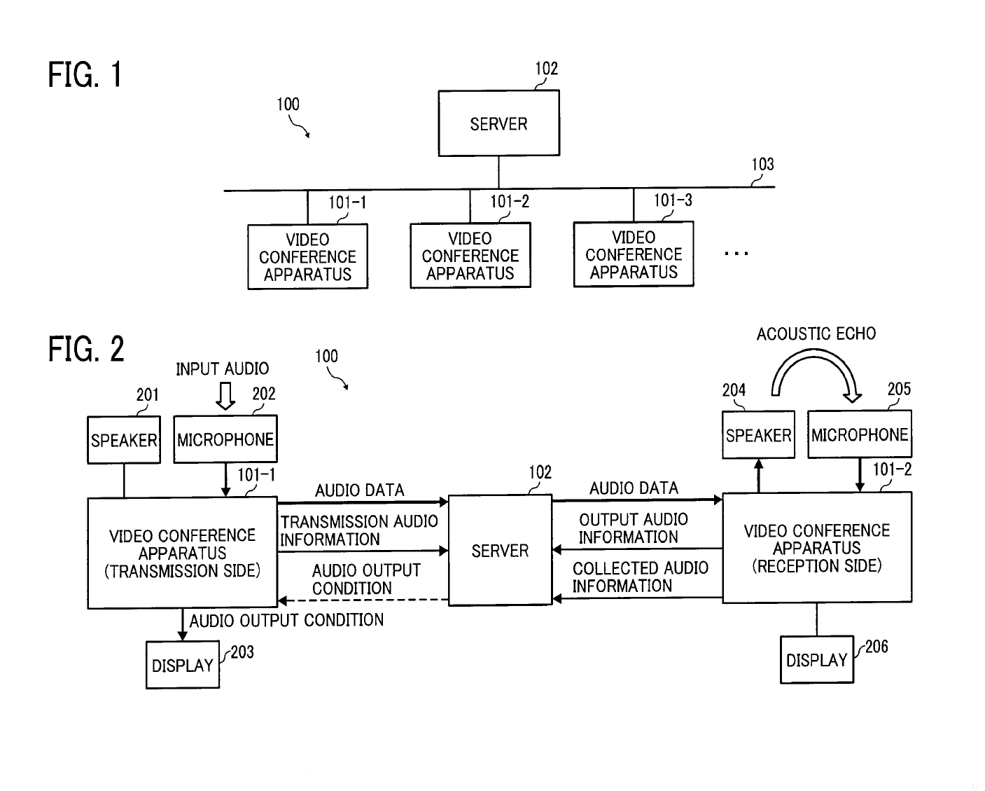

FIG. 1 is a schematic configuration of a conference system 100 of one or more example embodiments of the present invention. The conference system 100 includes, for example, a plurality of video conference apparatuses 101-1 to 101-3, and a server 102 connectable or couple-able via a network 103 such as the Internet, in which the video conference apparatuses 101-1 to 101-3 and the server 102 can communicate data or information one to another via the network 103 such as a wired network and/or a wireless network. In this description, each of the plurality of video conference apparatuses 101-1 to 101-3 may be simply referred to the “video conference apparatus 101” when the video conference apparatus indicates any one of the video conference apparatuses. The conference system 100 is employed as an example of a communication system.

The video conference apparatus 101 is employed as an example of a communication apparatus, which is a terminal apparatus configuring the conference system 100. The video conference apparatus 101 is, for example, typical information processing apparatuses such as personal computer (PC), tablet terminals, smartphones, and terminals specifically used for the conference system 100.

The server 102 controls various processing such as monitoring a connection status whether the server 102 is connected or coupled to the video conference apparatuses 101-1 to 101-3, a connection control of apparatuses when a conference or meeting starts and ends, and a data transmission and reception control of image (e.g., movie images) and audio (e.g., voice) during a conference. The server 102 is, for example, an information processing apparatus having a typical configuration of computer. For example, one of the video conference apparatuses 101 transmits image data and audio data to the server 102, and the server 102 transfers the received image data and audio data to other video conference apparatus 101 used for a conference. Further, the video conference apparatuses 101 used for the conference can receive the image data and audio data from the server 102. The image data means, for example, data of still images and movie images to be used in the conference, and the audio data means, for example, data of voices, sound, music, effect sound and the like to be used in the conference.

For example, when a conference is held using the video conference apparatuses 101-1, 101-2, and 101-3 as illustrated in FIG. 1, data can be transmitted from the video conference apparatus 101-1 to the video conference apparatuses 101-2 and 101-3 via the server 102. Further, data can be transmitted from the video conference apparatus 101-2 to the video conference apparatuses 101-1 and 101-3 via the server 102. With this configuration, a user of the video conference apparatus 101-1 can held a video conference with other users using the video conference apparatuses 101-2 and 101-3 by transmitting and receiving the image and audio data real time. FIG. 1 is just one of example configuration of the conference system 100. The number of the video conference apparatuses 101 used for the conference system 100 is two or more. Further, one of the video conference apparatuses 101 can communicate with other video conference apparatus 101 without using the server 102, which is known as peer to peer connection.

### (Operation of System)

FIG. 2 is a schematic view of an operation of the conference system 100 of one or more example embodiments of the present invention. Typically, transmission and reception of image data and audio data is performed bi-directionally in the conference system 100. For the simplicity of expression, the following description describes a case that audio is transmitted from the video conference apparatus 101-1 to the video conference apparatus 101-2. As shown in FIG. 2, the conference system 100 includes, the video conference apparatus 101-1 (e.g., transmission side, first communication apparatus), the server 102, and the video conference apparatus 101-2 (e.g., reception side, second communication apparatus).

The video conference apparatus 101-1 (e.g., transmission side) uses a microphone 202 to collect or pick up audio such as voice and sound during a conference, and converts the collected audio to audio data, and transmits the audio data to the server 102. Further, the video conference apparatus 101-1 acquires information related to audio (hereinafter, first audio information) included in the to-be-transmitted audio data, and transmits the acquired first audio information to the server 102. The first audio information includes, for example, information related to a signal level of audio corresponding to the to-be-transmitted audio data, and information related to setting of input audio volume of the microphone 202. The first audio information is also referred to primary audio data in this description.

The server 102 transmits or transfers the audio data received from the video conference apparatus 101-1 to the video conference apparatus 101-2. Further, when the video conference apparatus 101-1 is communicating with a plurality of the video conference apparatuses 101, the server 102 receives the audio data from the video conference apparatus 101-1 and then transmits the audio data to one or more partner communication apparatuses of the plurality of the video conference apparatuses 101.

The video conference apparatus 101-2 (e.g., reception side) receives the audio data transmitted from the video conference apparatus 101-1 (e.g., transmission side) via the server 102, and converts the received audio data to an audio signal (e.g., voice signal), and outputs the audio signal (e.g., voice signal) from a speaker 204. The speaker 204 converts the input audio signal to audio such as voice, and outputs the audio.

Further, in this processing, the video conference apparatus 101-2 (e.g., reception side) acquires information related to the output audio (hereinafter, second audio information), and transmits the acquired second audio information to the server 102. The second audio information includes, for example, information related to a signal level of the output audio output from the speaker 204, and information related to setting of output volume of the audio output from the speaker 204.

Further, the video conference apparatus 101-2 (e.g., reception side) uses a microphone 205 to collect or pick up an audio echo such as acoustic echo output from the speaker 204. Further, the video conference apparatus 101-2 (e.g., reception side) acquires information related to the collected audio (hereinafter, third audio information), and transmits the acquired third audio information to the server 102. The third audio information includes, for example, information related to the volume of acoustic echo of the audio such as voice output from the speaker 204 (e.g., sound pressure level). The third audio information is also referred to secondary audio data in this description while the first audio information is referred to the primary audio data.

Based on the first audio information received from the video conference apparatus 101-1, and the second audio information and the third audio information received from the video conference apparatus 101-2, the server 102 generates information indicating an output condition of audio output from the video conference apparatus 101-2, and transmits the information indicating the output condition of the audio output from the video conference apparatus 101-2 to the video conference apparatus 101-1 (e.g., transmission side). When the video conference apparatus 101-1 (e.g., transmission side) receives the information indicating the output condition of the audio at the video conference apparatus 101-2 (e.g., reception side) from the server 102, the video conference apparatus 101-1 displays the received information on a display 203. For example, the information indicating the output condition of the audio includes a display image related to an output level of the audio output from the video conference apparatus 101-2 (e.g., reception side) such as an audio volume meter.

Preferably, the information indicating the output condition of the audio displayable on the display 203 includes messages corresponding to each of the conditions such as the first audio information, the second audio information and the third audio information. For example, if the first to the third audio information are all normal, the information indicating the output condition of the audio includes a message of “condition of audio is good,” or if the first to the third audio information are all normal, no message is displayed.

By contrast, if a signal level of the audio included in to-be-transmitted audio data does not reach a given value even if setting data of input audio level of the first audio information is normal, the information indicating the output condition of the audio includes a message such as “check connection of microphone” to identify a malfunction or failure point.

Further, as to another preferable configuration, the information indicating the output condition of the audio can display a signal level of audio included in the to-be-transmitted audio data, a signal level of the output audio, and a signal level of the acoustic echo. For example, when the signal level of audio included in the transmitted audio data and the signal level of output audio are normal, and audio such as voice can be received and heard from a partner communication apparatus, but the signal level of the acoustic echo is low, a user can estimate that the speaker 204 has a problem.

As above described, since the conference system 100 can display the information indicating the output condition of the audio based on the first audio information, the second audio information, and the third audio information, if the audio output has a problem, the user can easily identify a cause of failure.

### (Hardware Configuration)

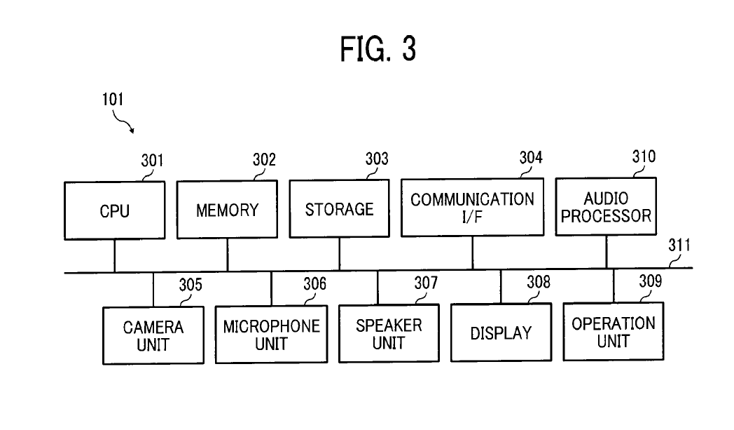

FIG. 3 is an example of a hardware configuration of the video conference apparatus 101, which may be a typical computer. The video conference apparatus 101 includes, for example, a central processing unit (CPU) 301, a memory 302, a storage 303, a communication interface (I/F) 304, a camera unit 305, a microphone unit 306, a speaker unit 307, a display 308, an operation unit 309, an audio processor 310, and a bus 311.

The CPU 301 reads programs and data from, for example, the storage 303, and executes the programs to devise each of functions of the video conference apparatus 101. The CPU 301 can be a processor, processing circuit, or circuitry. The memory 302 is, for example, a storing device such as a random access memory (RAM) and a read only memory (ROM). The RAM is a volatile memory useable as a working area of the CPU 301. The ROM is a non-volatile memory storing, for example, activation program of the video conference apparatus 101, and setting data. The storage 303 is, for example, a storage device such as a hard disk device (HDD), a solid state drive (SSD), and a flash ROM that stores programs used for apparatus control and video conference control executable by the CPU 301, and various data. The storage 303 used as a storage unit stores log data, which is prepared by adding the acquired date data to the property data. The storage 303 stores log data, which can be generated or prepared by adding the acquired date data to audio-related data such as cancelling amount data. The storage 303 acquires transmitted data amount of secondary audio data transmitted to a partner or counterpart communication apparatus such as the video conference apparatus 101-1, and stores log data, which can be generated or prepared by adding the acquired date data to the transmitted data amount.

The communication I/F 304 is a communication unit to connect or couple the video conference apparatus 101 to the network 103 so that one video conference apparatus 101 can communicate data with other video conference apparatus 101 and the server 102. The communication I/F 304 is an interface that can be used with a wired local area network (LAN) such as 10Base-T, 100Base-TX, 1000Base-T, and a wireless LAN such as 802.11a/b/g/n. The camera unit 305 includes, for example, a camera to capture images of participants of a video conference, and an interface to convert the captured images to image data, in which the camera can be disposed in the video conference apparatus 101, or disposed outside the video conference apparatus 101.

The microphone unit 306 includes, for example, a microphone to collect or pick up audio such as voices of conference participants, and audio such as acoustic echo output from the speaker unit 307, and an interface to convert the collected audio to audio data. Further, the microphone unit 306 has a function of adjusting an audio volume of audio input from the microphone by executing a program by using the CPU 301. Further, the microphone unit 306 can include a plurality of microphones such as one microphone for collecting voices of conference participants, and another microphone for collecting other audio such as acoustic echo output from the speaker unit 307. The microphone of the microphone unit 306 can be disposed in the video conference apparatus 101, or disposed outside the video conference apparatus 101.

The speaker unit 307 includes, for example, an interface to convert the received audio data to an audio signal such as a voice signal, and a speaker to convert the audio signal to audio such as voice. Further, the speaker unit 307 has a function of adjusting an audio volume of audio output from the speaker by executing a program by using the CPU 301. The speaker of the speaker unit 307 can be disposed in the video conference apparatus 101, or disposed outside the video conference apparatus 101.

The display 308 is, for example, a display device such as liquid crystal display (LCD). The operation unit 309 is, for example, a user operation receiver such as operation buttons, a key board, and a touch panel. The display 308 and the operation unit 309 can be integrated into a touch panel display. The display 308 and the operation unit 309 can be disposed in the video conference apparatus 101, or disposed outside the video conference apparatus 101.

Further, the video conference apparatus 101 can include the audio processor 310 that performs an audio processing such as an echo cancelling process. The audio processor 310 can be devised, for example, by a dedicated hardware, digital signal processor (DSP) or the like. Further, the audio processor 310 can be devised by executing a program by using the CPU 301. The bus 311 transmits, for example, address signals, data signals, and various control signals.

### (Functional Configuration)

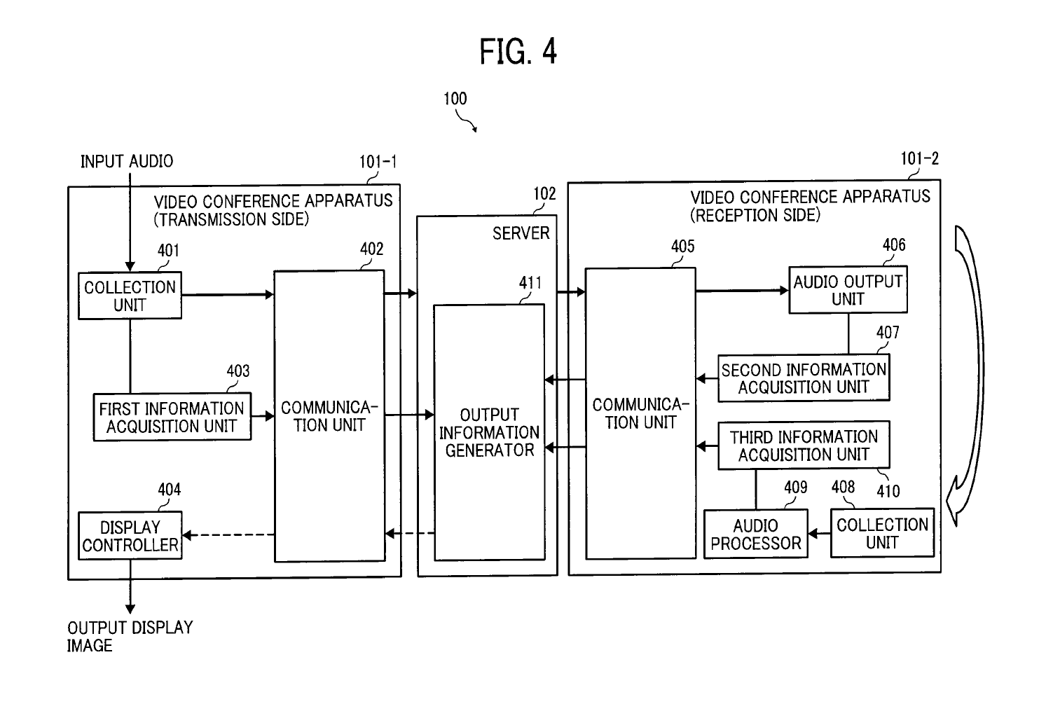

FIG. 4 is an example of a functional configuration of the conference system 100 of one or more example embodiments of the present invention.

### (Functional Configuration of Video Conference Apparatus Used as Transmission Side)

As shown in FIG. 4, the video conference apparatus 101-1 used as a transmission side includes, for example, a collection unit 401, a communication unit 402, a first information acquisition unit 403, and a display controller 404. The collection unit 401 collects or picks up audio made in a conference such as user voice, and can be devised, for example, as the microphone unit 306 of FIG. 3. The communication unit 402 is used for data transmission and reception (i.e., data communication) with the server 102 and the video conference apparatus 101-2, and can be devised, for example, as the communication I/F 304 of FIG. 3. In the configuration of FIG. 4, the communication unit 402 transmits audio data collected by the collection unit 401, and information acquired by the first information acquisition unit 403 to the server 102. Further, the communication unit 402 receives information transmitted from the server 102. Further, the communication unit 402 includes, for example, a codec that performs encoding and decoding of audio and image data. Further, the server 102 can perform a part of encoding and decoding of audio and image data.

The first information acquisition unit 403 acquires information related to audio (i.e., first audio information or primary audio information) included in the audio data collected by the collection unit 401, and the first information acquisition unit 403 can be devised, for example, by executing a program by using the CPU 301 of FIG. 3. The first audio information acquired by the first information acquisition unit 403 includes, for example, a signal level of audio included in the audio data collected or acquired by the collection unit 401, and setting of input audio volume of the collection unit 401 such as volume setting data of a microphone. Further, the first information acquisition unit 403 controls a transmission of the acquired first audio information to the server 102 via the communication unit 402.

With this configuration, the video conference apparatus 101-1 (e.g., transmission side) can transmit audio data that collects audio of conference including user voice to the video conference apparatus 101-2 (e.g., reception side) via the server 102. Further, the video conference apparatus 101-1 (e.g., transmission side) can acquire the first audio information including the signal level of audio included in the to-be-transmitted audio data, and setting data of input audio volume, and transmits the acquired first audio information to the server 102.

### (Functional Configuration of Video Conference Apparatus at Reception Side)

As shown in FIG. 4, the video conference apparatus 101-2 at the reception side includes, for example, a communication unit 405, an audio output unit 406, a second information acquisition unit 407, a collection unit 408, an audio processor 409, and a third information acquisition unit 410. The communication unit 405 is used for data transmission and reception (i.e., data communication) with the server 102 and the video conference apparatus 101-1, and can be devised, for example, as the communication I/F 304 of FIG. 3. In the configuration of FIG. 4, the communication unit 405 receives the audio data transmitted from the video conference apparatus 101-1 via the server 102. Further, the communication unit 405 transmits information acquired by the second information acquisition unit 407 and the third information acquisition unit 410 to the server 102. Further, the communication unit 402 includes, for example, a codec that performs encoding and decoding of audio and image. Further, the server 102 can perform a part of encoding and decoding of audio and image. The audio output unit 406 outputs audio based on the audio data received by the communication unit 405, and can be devised, for example, as the speaker unit 307 of FIG. 3.

The second information acquisition unit 407 acquires information (i.e., second audio information) related to audio output from the audio output unit 406, and the second information acquisition unit 407 can be devised, for example, by executing a program by using the CPU 301 of FIG. 3. The second audio information acquired by the second information acquisition unit 407 includes, for example, a signal level of audio output from the audio output unit 406, and setting of output audio volume of the audio output unit 406 such as volume setting data of the speaker.

Further, the second information acquisition unit 407 controls a transmission of the acquired second audio information to the server 102 via the communication unit 405. The collection unit 408 collects or picks up audio output from the audio output unit 406, and can be devised, for example, as the microphone unit 306 of FIG. 3. Further, the collection unit 408 can use the same microphone to collect or pick up the audio output from the audio output unit 406, and audio occurred in a conference, or the collection unit 408 can include a dedicated microphone to collect or pick up the audio output from the audio output unit 406

The audio processor 409 can perform audio processing to the audio collected by the collection unit 408, and can be devised, for example, as the audio processor 310 of FIG. 3, or by executing a program by using the CPU 301 of FIG. 3. The audio processing performable by the audio processor 409 includes, for example, a process of identifying a signal level of an acoustic echo caused by audio such as voice output from the audio output unit 406 among audio collected by the collection unit 408. For example, the audio processor 409 performs an echo cancelling process to remove a component (e.g., acoustic echo) of audio output from the audio output unit 406 from the audio collected by the collection unit 408, and identifies a signal level of the acoustic echo based on a cancelling amount of the acoustic echo. The audio processor 409, which can be used as a property acquisition unit or audio property acquisition unit, acquires property data indicating audio property while removing commented contents based on audio data. The audio processor 409 acquires the property data of environment where the communication apparatus is placed based on noise data which is obtained when no target audio such as voice is not included in audio data. The audio processor 409 acquires sound pressure level and/or frequency characteristics as the property data.

The third information acquisition unit 410 acquires information (i.e., third audio information) related to the audio collected by the collection unit 408, and can be devised, for example, by executing a program by using the CPU 301 of FIG. 3. The third audio information acquired by the third information acquisition unit 410 includes, for example, the volume of acoustic echo of the audio output from the audio output unit 406, and the sound pressure level of the collected audio identified by the audio processor 409. Further, the third information acquisition unit 410 controls a transmission of the acquired third audio information to the server 102 via the communication unit 405. The third information acquisition unit 410 acquires audio data from the audio processor 409 by performing an analog/digital (A/D) conversion to the audio collected by the collection unit 408 by using the audio processor 409. With this configuration, the video conference apparatus 101-2 (e.g., reception side) can output audio based on audio data received from the video conference apparatus 101-1 (e.g., transmission side), and collect or pick up the output audio such as voice. Further, the video conference apparatus 101-2 acquires the second audio information related to the output audio, and the third audio information related to the collected audio, and transmits the acquired second audio information and third audio information to the server 102.

### (Functional Configuration of Server)

The server 102 includes, for example, an output information generator 411. The output information generator 411 generates information indicating an output condition of the audio output from the video conference apparatus 101-2 based on the first audio information received from the video conference apparatus 101-1, and the second audio information and the third audio information received from the video conference apparatus 101-2. Further, the server 102 transmits the generated information indicating the output condition of the audio output from the video conference apparatus 101-2 (e.g., reception side) to the video conference apparatus 101-1 (e.g., transmission side). The output condition of the audio output from the video conference apparatus 101-2 (e.g., reception side) will be described later in detail.

The above described functional configuration is just one example, and the functional configuration is not limited hereto. For example, a plurality of video conference apparatuses 101-2 (e.g., reception side) can be used, and the video conference apparatus 101-1 (e.g., transmission side) can include the output information generator 411. Further, the functional configuration of FIG. 4 mainly illustrates functions of the one or more example embodiments while omitting other functions included in typical conference systems.

### (Flow of Process)

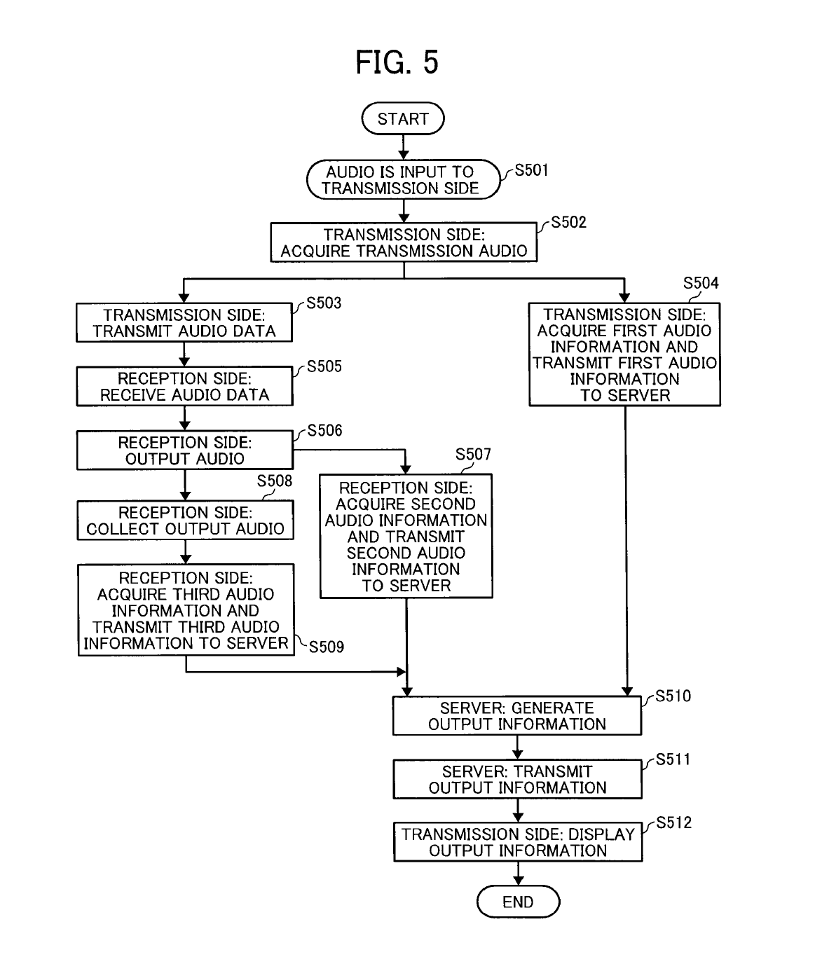

FIG. 5 is a flowchart showing the steps of a process of the conference system 100 of the one or more example embodiments of the present invention. For example, when a conference participant makes a comment, audio such as voice is input to the video conference apparatus 101-1 at the transmission side (step S501). The video conference apparatus 101-1 acquires to-be-transmitted audio by using the collection unit 401 (step S502).

Further, the acquired audio is converted to audio data, and then the audio data is transmitted to the video conference apparatus 101-2 at the reception side via the server 102 (step S503). Further, the video conference apparatus 101-1 acquires the first audio information related to the audio included in the transmitted audio data, and transmits the acquired first audio information to the server 102 (step S504).

The video conference apparatus 101-2 (e.g., reception side) receives the audio data transmitted from the video conference apparatus 101-1 (e.g., transmission side) (step S505) via the server 102, and outputs audio such as voice by using the audio output unit 406 based on the received audio data (step S506). Further, the video conference apparatus 101-2 acquires the second audio information related to the output audio output from the audio output unit 406 of the video conference apparatus 101-2 (e.g., reception side), and transmits the acquired second audio information to the server 102 (step S507).

Further, the video conference apparatus 101-2 (e.g., reception side) collects or picks up the audio output from the audio output unit 406 by using the collection unit 408 (step S508). Further, the video conference apparatus 101-2 acquires the third audio information related to the collected audio, and transmits the acquired third audio information to the server 102 (step S509).

The server 102 can generate output information based on the first audio information received from the video conference apparatus 101-1, and the second audio information and the third audio information received from the video conference apparatus 101-2 (step S510), and transmits the output information to the video conference apparatus 101-1 (step S511). The video conference apparatus 101-1 (e.g., transmission side) displays the output information based on the output information received from the server 102 (step S512).

By performing the above described processing shown in FIG. 5, the audio such as voice transmitted from the video conference apparatus 101-1 (e.g., transmission side) can be output from the video conference apparatus 101-2 (e.g., reception side), and the output information indicating conditions or status of the output audio output from the video conference apparatus 101-2 (e.g., reception side) can be displayed on the video conference apparatus 101-1 (e.g., transmission side). For example, the output information displayed on the video conference apparatus 101-1 is an audio volume meter that indicates an output level of the audio output from the video conference apparatus 101-2 (e.g., reception side).

For example, the video conference apparatus 101-2 (e.g., reception side) collects the audio output from the audio output unit 406 by using the collection unit 408, and acquires a sound pressure level of the collected audio as the third audio information. The video conference apparatus 101-1 (e.g., transmission side) can display the sound pressure level of the collected audio as the information (i.e., output information) indicating the output condition of the output audio.

However, for example, when the microphone of the video conference apparatus 101-2 (e.g., reception side) is temporally muted by a user operation, the video conference apparatus 101-1 (e.g., transmission side) can display the information indicating the output condition of the audio of the output audio based on an output level of the output audio included in the second audio information.

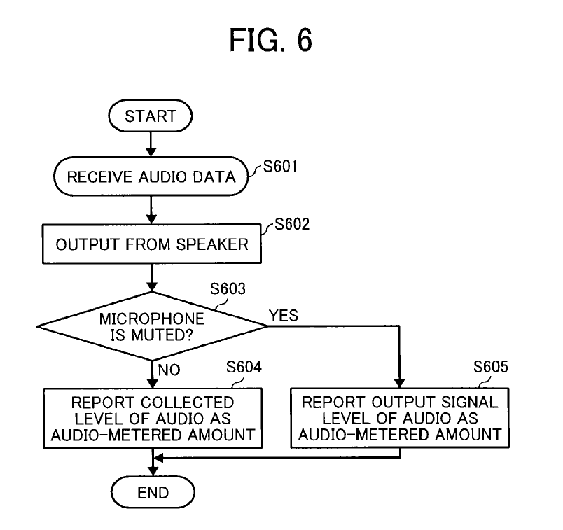

FIG. 6 is a flowchart showing the steps of a process of the video conference apparatus 101 at the reception side of one or more example embodiments of the present invention. When the video conference apparatus 101-2 (e.g., reception side) receives audio data (step S601), the video conference apparatus 101-2 outputs audio such as voice from the speaker unit 307 based on the received audio data (step S602). Then, the video conference apparatus 101-2 determines whether the microphone is muted (step S603).

If the microphone is not muted (S603: NO), the video conference apparatus 101-2 reports a level of audio collected by the collection unit 408 to the server 102 as the audio-metered amount (step S604). By contrast, if the microphone is muted (S603: YES), the video conference apparatus 101-2 reports a signal level of the audio output from the audio output unit 406 to the server 102 as the audio-metered amount (step S605). By performing the above described processing, even if the microphone of the video conference apparatus 101-2 (e.g., reception side) is muted, a suitable audio volume meter can be displayed.

### (Identification of Failure Point)

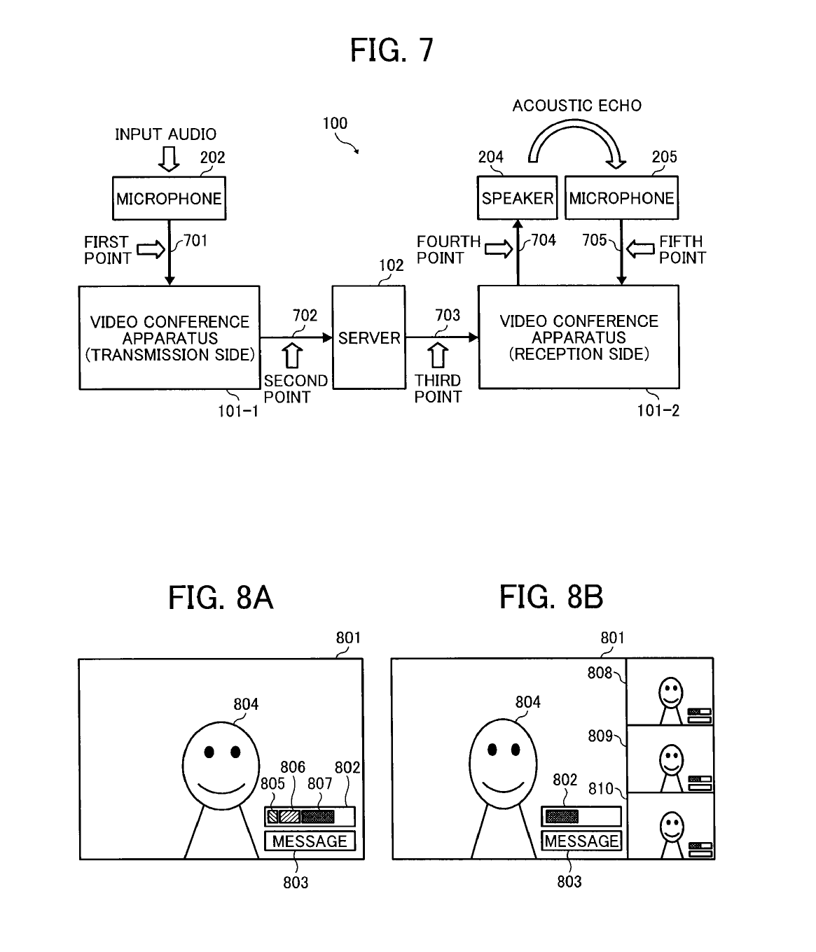

FIG. 7 is a scheme of detecting a failure point of the conference system 100 of the one or more example embodiments of the present invention. The above described conference system 100 can display the audio volume meter, and can further display messages corresponding to the first audio information, the second audio information and the third audio information as the information indicating the output condition of the audio output from the video conference apparatus 101-2 (e.g., reception side).

For example, the first audio information includes information related to a signal level of audio included in the transmitted audio data, and information related to the setting of input audio volume of the video conference apparatus 101-1 such as volume setting data of microphone. With this configuration, for example, when the setting data of the input audio volume is within a normal range but the signal level of audio is low, it can be estimated that some failure occurs at a first point 701 shown in FIG. 7. In this case, messages such as “check connection of microphone” and “replace microphone with spare microphone” can be displayed as the information indicating the output condition of the output audio.

Further, for example, when the signal level of transmitted audio is normal but the signal level of the output audio included in the second audio information does not satisfy a suitable level, it can be estimated that a second point 702 is normal but some failure occurs at the server 102 and/or a third point 703 shown in FIG. 7. In this case, messages such as “disconnect communication, and reconnect to server again” and “reboot or reactivate video conference apparatus used as partner communication apparatus” can be displayed as the information indicating the output condition of the output audio.

Further, for example, when the setting data of output audio volume included in the second audio information is normal and the signal level of audio input to the microphone 205 is normal but the acoustic echo cannot be detected, it can be estimated that some failure occurs at a fourth point 704 shown in FIG. 7. In this case, messages such as “check connection of speaker of partner communication apparatus,” and “request partner communication apparatus to check speaker” can be displayed as the information indicating the output condition of the output audio.

Further, for example, when the setting data of output audio volume included in the second audio information is normal but the audio related to the conference and the acoustic echo input to the microphone 205 cannot be detected, it can be estimated that some failure occurs at a fifth point 705 shown in FIG. 7. In this case, messages such as “check connection of microphone of partner communication apparatus” or “request partner communication apparatus to check microphone” can be displayed as the information indicating the output condition of the output audio.

Preferably, the conference system 100 can be set with information correlating combinations of the first audio information, the second audio information and the third audio information, and messages corresponding to each of the combinations. For example, the output information generator 411 includes the correlating information, and determines one or more messages corresponding to each of the combinations of the first audio information, the second audio information and the third audio information based on the correlating information. Further, the output information generator 411 can generate output information including the determined message and an audio volume meter.

FIG. 7 describes one case that the failure points are detected between two sites. Further, when communication is performed between greater numbers of sites, based on the information indicating the output condition of the audio output from a plurality of sites, it can be estimated some failure occurs at one or more video conference apparatuses placed at one or more sites.

Further, when the conference system 100 determines that the setting data of input audio volume is not correct based on the first audio information, the conference system 100 can be configured to change the setting data of input audio volume to a correct value automatically. Further, when the conference system 100 determines that the setting data of output audio volume is not correct based on the second audio information, the conference system 100 can be configured to change the setting data of output audio volume to a correct value automatically.

### (Display on Screen)

FIGS. 8A and 8B illustrate examples of screen display of the video conference apparatus 101 of one or more example embodiments of the present invention. FIG. 8A illustrates an example of screen display when a conference is held between two sites, and FIG. 8B illustrates an example of screen display when a conference is held between three or more sites.

In a case of FIG. 8A, the video conference apparatus 101-1 has a screen display 801 including, for example, an audio volume meter 802, a message reporting area 803, and a user image 804 of a partner communication apparatus. The audio volume meter 802 is an example of information indicating the output condition of the audio output from the video conference apparatus 101-2 (e.g., reception side). For example, the audio volume meter 802 indicates a volume of the output audio by using a bar having a length to indicate levels of audio volume. For example, the audio output from the speaker 204 disposed in the video conference apparatus 101-2 (e.g., reception side) is collected by using the microphone 205, and the audio volume meter 802 determines the audio volume based on the sound pressure level (dB) of the collected audio. The message reporting area 803 displays messages corresponding to the above described first audio information, second audio information and third audio information used as the information indicating the output condition of the audio output from the video conference apparatus 101-2 (e.g., reception side). For example, when the audio output has a failure, the message reporting area 803 displays a message corresponding to the failure. The displayable messages includes, for example, “gain setting of microphone at transmission side is small,” “transmitted audio level at transmission side is low,” “received audio level at reception side is small,” “volume of speaker at reception side is small,” and “audio volume output from speaker at reception side is small.” When the failure occurs to the audio output, a user of the conference system 100 can easily identify a cause of failure and a failure point by checking indications displayed on the audio volume meter 802 and the message reporting area 803.

Further, as illustrated in FIG. 8A, the audio volume meter 802 can preferably include, a transmission audio level 805, an output audio level 806, and a collected audio level 807, in which each of the transmission audio level 805, the output audio level 806, and the collected audio level 807 can be displayed by changing colors with each other. By checking these indicators, a user can intuitively determine which failure detection point should be checked when the audio level is low. For example, when the transmission audio level 805 and the output audio level 806 are normal but the collected audio level 807 is not detected, it can be estimated that the fourth point 704 and the fifth point 705 (FIG. 7) should be checked.

Further, in a case of FIG. 8B, the screen display 801 of the video conference apparatus 101-1 includes images 808, 809, and 810 of other three sites in addition to the display of FIG. 8A. In the case of FIG. 8B, the audio volume meter 802 and the message reporting area 803 can be displayed on each of the images 808, 809, and 810 corresponding to other three sites, and the audio volume meter 802 in each of the images 808, 809, and 810 displays the audio level of audio collected by the collection unit 408 at each of other three sites.

For example, if only the level of the audio volume meter of the image 808 is low, the user can estimate that a failure point exists at a site corresponding to the image 808. Further, if the level of audio volume meters of all of the images 808, 809, and 810 are low, the user can estimate that a failure point (e.g., connection failure of microphone) exists at the video conference apparatus 101-1 (e.g., transmission side). Further, since the message reporting area 803 can display messages having specific information, the user of the conference system 100 can identify a failure point more specifically.

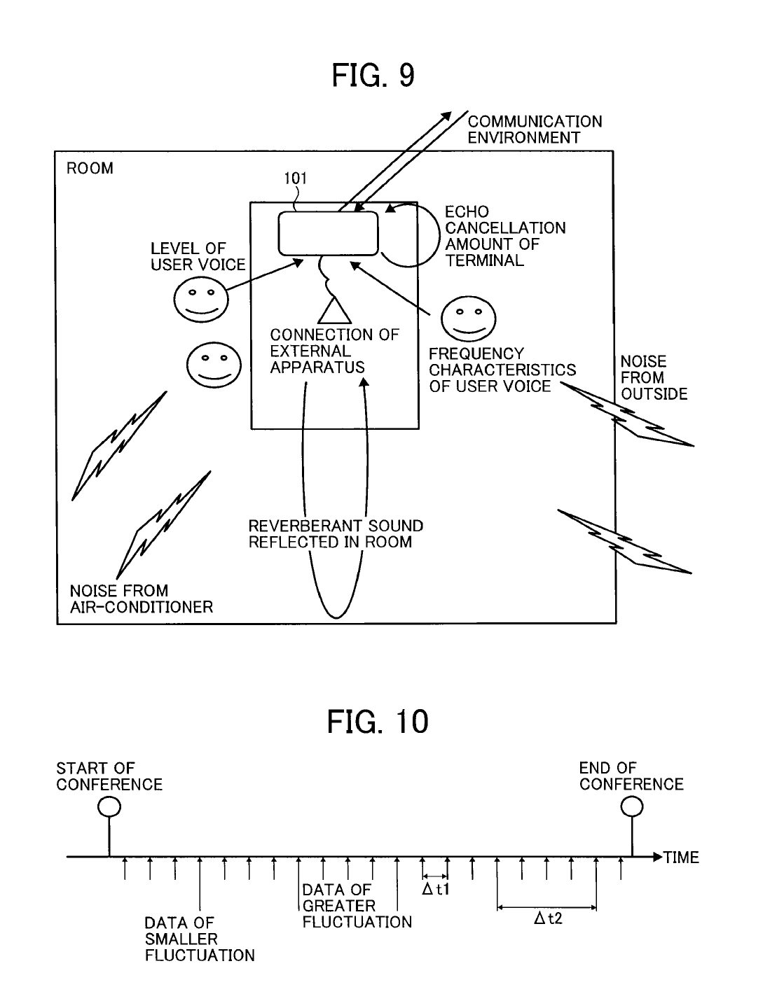

FIG. 9 is a schematic view of environment where the video conference apparatus 101 is placed, in which the video conference apparatus 101 may receive various effects from the environment. When teleconference such as a video conference or telephone conference is held, various factors affect the quality of audio replayed at each of the sites. Therefore, to comprehend a user environment such as acoustic environment used for the video conference apparatus 101, the video conference apparatus 101 is configured to acquire and store various environmental factor or data as log data automatically. The environmental factor or data can be also referred to property data.

The environmental factor or data (i.e., property data) includes, for example, following data, which can be acquired alone or with a combination. The environmental factor or data is information indicating quality of replayed audio and property of replayed audio when a telephone or video conference is held, and does not include the contents of the telephone or video conference. The information of the quality of audio and audio property are affected by external environment factors, and these environmental factors are also considered. The environmental factor or data includes, for example, followings (1) to (6): (1) as to a user voice, sound pressure level (decibel value (dB)) indicating an audio level of the user voice, and frequency characteristics data such as a level of each of frequency components indicating voice tone of the user voice (e.g., high tone voice, low tone voice) are acquired, (2) as to noise, sound pressure level (decibel value (dB)) and frequency characteristics data of noise when a user does not make comments (e.g., noise of air-conditioning, noise occurring in room, noise from outside entering room, noise by user movement), and noise collected by the video conference apparatus 101 at a timing when no audio is input are acquired, (3) sound pressure level (decibel value (dB)) and frequency characteristics data of reverberant sound occurred by a reflection of audio or noise on a wall of a conference room is acquired, (4) echo cancellation amount data of the video conference apparatus 101 (i.e., echo attenuated amount) is acquired, (5) noise removing amount data of the video conference apparatus 101 (i.e., decibel value (dB)dB of noise attenuated amount) is acquired, and (6) communication environment data (transmitted data amount, received data amount), and data size and bit rate used for communication are acquired By using these information, environmental factors or parameters indicating the environment that the user is using can be extracted, and the extracted environmental factors can be used to comprehend factors causing the audio failure. Since the above described information does not include the commented contents of the users, confidentiality of communication can be secured.

FIG. 10 is a schematic chart for setting a timing of inputting audio to the video conference apparatus 101. The above described environmental factors can be acquired by performing the processing at the video conference apparatus 101. However, if data is acquired continuously, processing data amount becomes too great. Therefore, an acquisition internal Δt1 is set for information or data having greater fluctuation, and an acquisition internal Δt2 is set for information or data having smaller fluctuation, in which the acquisition internal Δt2 is set longer than the acquisition internal Δt1 such as “Δt2>4×Δt1” to acquire data. The acquisition internal Δt2 and the acquisition internal Δt1 can be set based on experiments, in which (1) voice (e.g., level, tone) made by users is information having greater fluctuation because voice changes depending on speakers, and communication environment data (transmitted data amount, received data amount) of the voice is also information having greater fluctuation, and thereby the acquisition internal Δt1 is employed, and (2) the reverberant sound and noise when the user does not make comments is information having smaller fluctuation, and thereby the acquisition internal Δt2 is employed. The information related to the audio processing by the video conference apparatus 101 can be related to the processing amount of the video conference apparatus 101, and thereby the information related to the audio processing by the video conference apparatus 101 is acquired when fluctuation occurs. The reverberant sound of conference room can be acquired preferably as constant audio signal used as one of environmental factors. For example, the reverberant sound of conference room can be acquired at the start of conference and at the end of conference by outputting a reference sound (i.e., sound having reference frequency and reference level) from the speaker and collecting by the microphone.

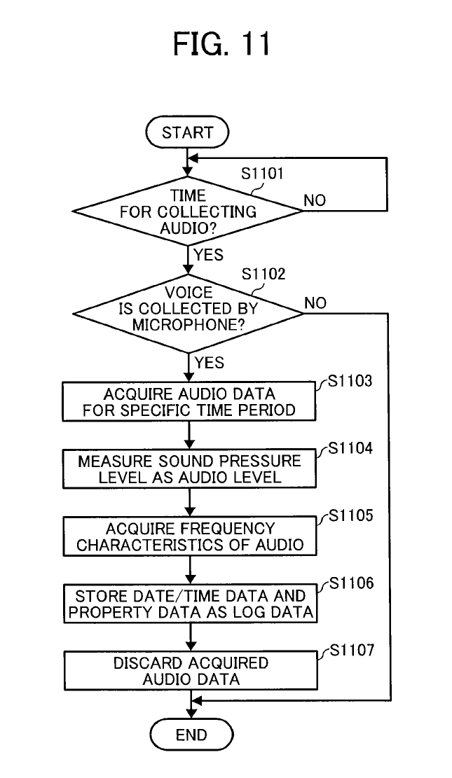

FIG. 11 is a flowchart showing the steps of a control process of acquiring audio data by using the video conference apparatus 101. At step S1101, the third information acquisition unit 410 determines whether a time of collecting audio comes. Since the audio has greater fluctuation, the third information acquisition unit 410 measures the audio using the acquisition internal Δt1, which is a shorter acquisition internal. When the collection timing comes (S1101: YES), the sequence proceeds to step S1102.

Then, at step S1102, the third information acquisition unit 410 determines whether the collection unit 408 can collect audio such as voice made by a user by using a microphone. If the voice made by the user can be can collected (S1102: YES), the sequence proceeds to step S1103. If the voice cannot be collected (S1102: NO), data acquisition is cancelled, and the sequence is ended. By contrast, if the collection unit 408 can collect the audio (S1102: YES), at step S1103, the third information acquisition unit 410 acquires audio data input from the collection unit 408 for a specific acquisition time period, and then the third information acquisition unit 410 transfers the audio data to the audio processor 409, and the audio processor 409 stores the audio data in the storage 303, with which the audio data to be analyzed can be stored in the storage 303.

At step S1104, the third information acquisition unit 410 measures the sound pressure level as the audio level of audio data. Therefore, the third information acquisition unit 410 acquires the sound pressure level identified by the audio processor 409, in which the audio processor 409 acquires the audio data from the storage 303, and calculates the maximum value, minimum value, and the averaged value of the sound pressure level of the audio data acquired for the specific acquisition time period, and outputs the maximum value, minimum value, and averaged value of the sound pressure level to the third information acquisition unit 410.

At step S1105, the third information acquisition unit 410 acquires frequency characteristics of the audio including various frequency components, in which the third information acquisition unit 410 acquires the frequency characteristics identified by the audio processor 409 as user voice property, wherein the frequency characteristics includes various frequency components such as high tone voice and low tone voice. In this process, the audio processor 409 acquires the audio data from the storage 303, and calculates a level of audio at one or more frequencies as the sound pressure level expressed by “dB value” corresponded to the frequency characteristics of the audio data acquired during the specific acquisition time period. If the acquiring frequency interval or span is set too small, data amount and processing load increases. Therefore, to reduce the data amount and processing load, data is acquired with a step of 500 Hz such as 500 Hz, 1000 Hz, and 1500 Hz. Since the acquired audio data is, for example, human voice, the frequency range of 20 Hz to 3000 Hz is enough for the processing.

At step S1106, the third information acquisition unit 410 stores acquired date data such as data and time data and the measured property data in the storage 303 as log data. Specifically, the third information acquisition unit 410 generates the log data by adding the acquired date data to the property data composed of the sound pressure level acquired at step S1104, and the frequency characteristics acquired at step S1105, and stores the log data in the storage 303. Then, at step S1107, the third information acquisition unit 410 deletes and discards the audio data acquired for the specific acquisition time period and stored in the storage 303, with which the third information acquisition unit 410 discards the audio data acquired for the specific acquisition time period from the storage 303. With this configuration, the audio data corresponding to the commented contents of users can be deleted, with which confidentiality of communication can be secured. Further, based on noise data in the acquired audio data when no comments are made, the audio processor 409 can acquire the sound pressure level and the frequency characteristics of the environment where the communication apparatus is placed as environmental property data, and the storage 303 can store the log data composed of the environmental property data added with date data when the environmental property data is acquired.

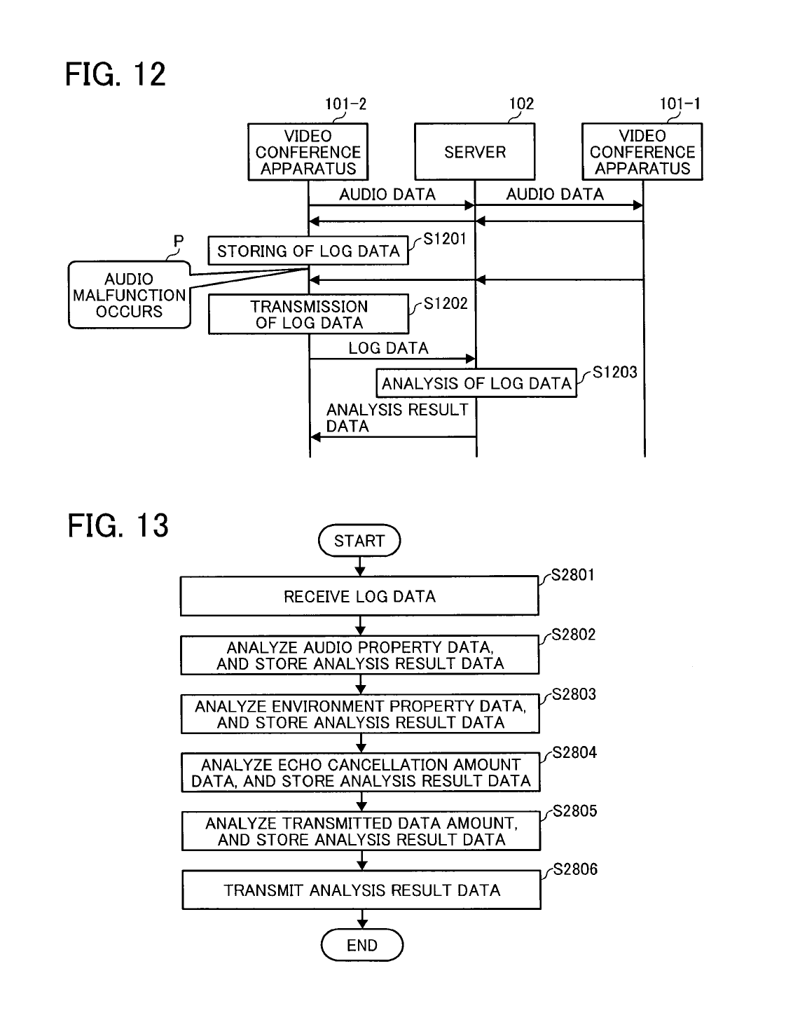

FIG. 12 is a sequential chart of an operation of uploading log data when an audio failure occurs at the video conference apparatus. The video conference apparatus 101-1 and the video conference apparatus 101-2 perform a video conference by setting the server 102 between the video conference apparatus 101-1 and the video conference apparatus 101-2, in which audio data and image data such as movie data are communicated, and the log data is stored in the storage 303 during the video conference (S1201). In this configuration, an audio failure that a user feels oddness may occur. For example, when the video conference apparatus 101-2 receives audio data from a partner apparatus such as the video conference apparatus 101-1, noise may exist in the audio data received from the video conference apparatus 101-1, commented contents may not be received clearly, commented contents may be interrupted and not received, or voice output at one video conference apparatus 101 may be returned back from the partner video conference apparatus as an echo, with which the audio failure occurs.

Then, the user determines that audio failure and/or malfunction occurs to the video conference apparatus 101 and the video conference system 100. Then, the user calls a service station of a vendor of the video conference apparatus 101 to request a repair of the audio failure and/or malfunction. Then, service person at the service station informs a message of “press a tool box button, and then press a log data upload button” to the user so that the log data can be transmitted to the server 102, who may be at the service station, in which the screen display of the display 308 displays the tool box button as a user interface (UI). When the tool box button is pressed by the user, the “log data upload” button is displayed on the display 308. When the “log data upload” button is pressed by the user, the video conference apparatus 101-2 proceeds to a log data upload mode.

Then, the video conference apparatus 101-2 acquires the log data, stored in the storage 303, from the storage 303, and the communication unit 405 transmits the log data to the server 102 placed in the service station (S1202). When the server 102 receives the log data from the video conference apparatus 101-2, the server 102 analyzes the log data (S1203), and transmits analysis result data to the video conference apparatus 101-2. In this processing, the server 102 acquires the log data received from the video conference apparatus 101-2, and can use the acquired log data including the property data such as the environmental factor for the analysis process. Specifically, the server 102 acquires the audio property data (i.e., sound pressure level, frequency characteristics data) indicating only audio property by removing the commented contents, the environmental property data (sound pressure level, frequency characteristics data) based on noise data when no comments is made in the audio data, the echo cancellation amount data, the noise removing amount data of the video conference apparatus 101, the received data amount and/or transmitted data amount of audio data communicated with other video conference apparatus as the log data to be used for the analysis process.

FIG. 13 is a flowchart showing the steps of a process of analyzing log data by the server 102 of one or more example embodiments of the present invention. The server 102 can be configured with a hardware similar to the video conference apparatus 101 shown in FIG. 3, wherein the server 102 includes at least, for example, a communication unit, a server controller. The server controller at least, for example, a read only memory (ROM), a random access memory (RAM), a central processing unit (CPU), and a hard disk drive (HDD) similar to the video conference apparatus 101 shown in FIG. 3. The CPU reads an operating system (OS) from the HDD, and loads the OS on the RAM to activate the OS. Under the control of OS, the CPU reads programs from the HDD to execute various processing such as the analysis processing. In this description, the server 102 uses the process shown in FIG. 13 to execute the analysis processing of the log data, but not limited hereto. For example, the video conference apparatus 101-2 can use the process shown in FIG. 13 to execute the analysis processing of the log data

At step S2801, the server controller of the server 102 receives the log data from the video conference apparatus 101-2 via a network, in which the server 102 can acquire the property data (i.e., sound pressure level, frequency characteristics data) indicating only audio property by removing the commented contents, the environmental property data (sound pressure level, frequency characteristics data) based on noise data when no comments is made in the audio data, the echo cancellation amount data, the noise removing amount data of the video conference apparatus 101, the received data amount and/or transmitted data amount of audio data communicated with other video conference apparatus as the log data to be used for the analysis process.

Then, at step S2802, the server controller analyzes the property data of the audio data included in the log data, and stores an analysis result data in the HDD. The property data of audio data includes the sound pressure level and the frequency characteristics indicating the acoustic environment in a room where the video conference apparatus 101-2 is placed. The server controller determines whether the sound pressure level exceeds a threshold. If the sound pressure level exceeds the threshold, it is determined that a user voice is too loud, and the server controller stores data indicating that the user voice is loud in the HDD as the analysis result data. By contrast, the server controller also determines whether the frequency characteristics is a low frequency range (e.g., 50 to 300 Hz), a middle frequency range (e.g., 400 to 1200 Hz), or a high frequency range (e.g., 1400 to 3000 Hz). If the frequency characteristics is the low frequency range or the high frequency range, it is determined that the user voice is not transmitted clearly or is degraded easily, and the server controller stores data indicating the user voice has non-preferable frequency range in the HDD as the analysis result data.

At step S2803, the server controller analyzes the environmental property data included in the log data, and stores analysis result data in the HDD. The environmental property data includes noise data when no comments is made. The server controller determines whether the noise data when no comments is made exceeds a threshold. If the noise data when no comments is made exceeds the threshold, the server controller determines the acoustic environment changes due to the noise of air-conditioning in a room, noise from outside, and noise occurred by person, which are factors other than the target audio. Therefore, the server controller stores data indicating abnormal environmental condition in the HDD as the analysis result data. By contrast, if the noise data when no comments is made does not exceed the threshold, the server controller determines that the noise removing function of the video conference apparatus 101-2 is operated normally, and stores data indicating normal environmental condition in the HDD as the analysis result data.

At step S2804, the server controller analyzes the echo cancellation amount data included in the log data, and stores the analysis result data in the HDD. The server controller determines whether the echo cancellation amount data exceeds an echo cancellation threshold. If the echo cancellation amount data exceeds the echo cancellation threshold, the server controller determines that the echo cancellation function is operated normally, and stores the data indicating normal echo cancellation amount in the HDD as the analysis result data. By contrast, if the echo cancellation amount data does not exceed the echo cancellation threshold, the server controller determines that the echo cancellation function is not operated normally, and stores data indicating abnormal echo cancellation amount in the HDD as the analysis result data. Further, at step S2804, the server controller performs the analysis processing to the echo cancellation amount data included in the log data, but not limited hereto. The server controller can perform the same analysis processing to the noise removing amount data of the video conference apparatus 101 included in the log data.

At step S2805, the server controller analyzes the transmitted data amount included in the log data, and stores the analysis result data in the HDD. The server controller determines whether the transmitted data amount exceeds a threshold. If the transmitted data amount exceeds the threshold, the server controller determines that the transmission is operated normally, and stores data indicating the transmitted data amount is normal in the HDD as the analysis result data. By contrast, if the transmitted data amount does not exceed the threshold, the server controller determines that the transmission is not operated normally, and the audio data is not transmitted correctly. Therefore, the server controller stores data indicating the transmitted data amount is abnormal in the HDD as the analysis result data.

At step S2806, the server controller reads the analysis result data stored in the HDD, and transmits the analysis result data to the video conference apparatus 101-2. When the video conference apparatus 101-2 receives the analysis result data from the server 102, the video conference apparatus 101-2 displays the analysis result data on a screen of the display 206, with which a user can visually check the failure status.

As to the above described one or more example embodiments of the present invention, based on the audio data collected by using a microphone from the acoustic environment, the property data (i.e., audio property) of audio data removing the commented contents can be acquired, and the property data added with the acquired date data can be used as log data, and the log data is stored. Therefore, the communication apparatus can record the log data to check audio failure status under the condition of securing confidentiality of communication

The above described one or more example embodiments of the present invention can include following configurations.

### (First Configuration)

As to the first configuration, the video conference apparatus 101-2 (one communication apparatus) receives primary audio data from the video conference apparatus 101-1 (counterpart communication apparatus) and outputs the primary audio data to the acoustic environment from the speaker 204 (audio output unit), and collects secondary audio data from the acoustic environment by using the microphone 205 (audio acquisition unit). Then, the video conference apparatus 101-2 (one communication apparatus) transmits the collected secondary audio data to the video conference apparatus 101-1 (counterpart communication apparatus). The video conference apparatus 101-2 includes the third information acquisition unit 410 (audio acquisition unit) that acquires the secondary audio data, and the audio processor 409 (property acquisition unit or audio property acquisition unit) that acquires property data of audio, removing the commented contents, output to the acoustic environment based on the collected secondary audio data, and the storage 303 (storage unit) that stores the property data added with date data when the property data is acquired as log data. With this configuration, the communication apparatus can record the log data to check audio failure status under the condition of securing confidentiality of communication.

### (Second Configuration)

As to the second configuration, the audio processor 409 (property acquisition unit or audio property acquisition unit) acquires property data of environment where the communication apparatus is placed based on noise data when no comment is made in the secondary audio data, and the storage 303 (storage unit) stores the property data of environment added with date data when the property data is acquired as log data. With this configuration, the communication apparatus can record the log data to check audio failure status under the condition of securing confidentiality of communication.

### (Third Configuration)

As to the third configuration, the video conference apparatus 101-2 (one communication apparatus) includes the audio processor 409 (audio processor) to cancel an acoustic echo of audio, and the storage 303 (storage unit) to acquire cancelling amount data of the acoustic echo from the audio processor, and to store the cancelling amount data add with date data when the property data is acquired as log data. With this configuration, the communication apparatus can record the log data to check audio failure status under the condition of securing confidentiality of communication.

### (Fourth Configuration)

As to the fourth configuration, the storage 303 (storage unit) acquires transmitted data amount of the secondary audio data transmitted to the video conference apparatus 101-1 (counterpart communication apparatus), and stores the transmitted data amount add with date data when the transmitted data amount is acquired as log data. With this configuration, the communication apparatus can record the log data to check audio failure status under the condition of securing confidentiality of communication.

### (Fifth Configuration)

As to the fifth configuration, the communication apparatus includes the CPU 301 (analyzer) to analyze one or more failure factors indicated in the secondary audio data based on the log data acquired from the storage 303 (storage unit). With this configuration, the communication apparatus can record the log data to check audio failure status under the condition of securing confidentiality of communication.

### (Sixth Configuration)

As to the sixth configuration, the audio processor 409 (property acquisition unit or audio property acquisition unit) acquires at least one of sound pressure level and frequency characteristics as the property data. With this configuration, the communication apparatus can record the log data to check audio failure status under the condition of securing confidentiality of communication.

### (Seventh Configuration)

As to the seventh configuration, the video conference apparatus 101-2 (one communication apparatus) includes the audio processor 409 (discarding unit) to discard the secondary audio data acquired by the third information acquisition unit 410 (audio acquisition unit). With this configuration, the communication apparatus can record the log data to check audio failure status under the condition of securing confidentiality of communication.

### (Eighth Configuration)

As to the eighth configuration, the communication system 100 includes two or more of the video conference apparatus 101 (communication apparatuses) of the first configuration to seventh configuration, and a server to communicate data with the two or more of the communication apparatuses, in which each of the communication apparatus includes the communication unit 405 (log data transmission unit) to transmit log data acquired from the storage 303 (storage unit) to the server 102, and the server 102 includes the server controller (analyzer) to analyze one or more failure factors indicated in the secondary audio data based on the log data received from the communication apparatus. With this configuration, the communication apparatus can record the log data to check audio failure status under the condition of securing confidentiality of communication.

### (Ninth Configuration)

As to the ninth configuration, a method of storing log data for a communication apparatus includes outputting a primary audio data received from a counterpart communication apparatus of the first configuration to seventh configuration to an acoustic environment of the communication apparatus; collecting secondary audio data from the acoustic environment by using the microphone (S1103), transmitting the collected secondary audio data to the counterpart communication apparatus, acquiring property data of audio, removing the commented contents, output to the acoustic environment based on the collected secondary audio data (S1104, S1105); and storing the acquired property data added with date data when the property data is acquired as log data in the storage 303 (storage unit) (S1106). With this configuration, the communication apparatus can record the log data to check audio failure status under the condition of securing confidentiality of communication.

### (Tenth Configuration)

As to the tenth configuration, a non-transitory storage medium stores a program that, when executed by a computer, causes the computer to execute the method of the ninth configuration.

As to the above described one or more example embodiments, the communication apparatus can record the log data to check audio failure status under the condition of securing confidentiality of communication.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A communication apparatus comprising:
an audio output unit to output primary audio data received from a counterpart communication apparatus to an acoustic environment of the communication apparatus;
an audio acquisition unit to collect secondary audio data from the acoustic environment, the collected secondary audio data is transmitted to the counterpart communication apparatus;
a property acquisition unit to acquire property data of audio based on the collected secondary audio data; and
a storage unit to store the acquired property data of audio added with date data when the property data of audio is acquired as log data.

2. The communication apparatus of claim 1, wherein the property acquisition unit acquires property data of environment where the communication apparatus is placed based on noise data when no comment is made included in the secondary audio data,
wherein the storage unit stores the property data of environment added with date data when the property data of environment is acquired as the log data.

3. The communication apparatus of claim 1, further comprising an audio processor to cancel an acoustic echo of audio,
wherein the storage unit acquires cancelling amount data of the acoustic echo from the audio processor, and stores the cancelling amount data added with date data when the cancelling amount data is acquired as the log data.

4. The communication apparatus of claim 1, wherein the storage unit acquires transmitted data amount of the secondary audio data transmitted to the counterpart communication apparatus, and stores the transmitted data amount added with date data when the transmitted data amount is acquired as the log data.

5. The communication apparatus of claim 1, further comprising an analyzer to analyze one or more failure factors indicated in the secondary audio data based on the log data acquired from the storage unit.

6. The communication apparatus of claim 2, wherein the property acquisition unit acquires at least one of sound pressure level and frequency characteristics as the property data of audio and the property data of environment.

7. The communication apparatus of claim 1, further comprising a discarding unit to discard the secondary audio data acquired by the audio acquisition unit.

8. A communication system comprising:
two or more of the communication apparatuses of claim 1; and
a server to communicate data with the two or more of the communication apparatuses,
wherein each of the communication apparatus comprises a log data transmission unit to transmit the log data acquired from the storage unit to the server, and the server comprises an analyzer to analyze one or more failure factors indicated in the secondary audio data based on the log data received from the communication apparatus.

9. A method of storing log data for a communication apparatus comprising:
outputting a primary audio data received from a counterpart communication apparatus to an acoustic environment of the communication apparatus;
collecting secondary audio data from the acoustic environment;
transmitting the collected secondary audio data to the counterpart communication apparatus;
acquiring property data of audio based on the collected secondary audio data; and
storing the acquired property data of audio added with date data when the property data of audio is acquired as log data.

10. A non-transitory storage medium storing a program that, when executed by a computer, causes the computer to execute the method of claim 9.
